(19) United States
(12) Patent Application Publication
(10) Pub. No.: US 2009/0310359 A1
(43) Pub. Date: Dec. 17, 2009

(54) LED LAMP

(75) Inventors: Po-Yao Hsiao, Tu-Cheng (TW); Kuan-Yu Chen, Tu-Cheng (TW); Chia-Shou Chang, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXCONN TECHNOLOGY CO., LTD., Taipei Hsien (TW)

(21) Appl. No.: 12/248,008

(22) Filed: Oct. 8, 2008

(30) Foreign Application Priority Data
Jun. 13, 2008 (CN) 200810067737.X

(51) Int. Cl. F21V 7/00

(52) U.S. Cl. 362/241; 362/346

(57) ABSTRACT

An LED lamp (100) includes a cover (10) having two concave reflective surfaces (121, 123), a base (21) disposing over the cover, a lens (40) locating in a middle of the base, and two LEDs (30) mounted on a bottom surface of the base. The lens and the LEDs face the reflective surfaces of the cover. The reflective surfaces each are a part of an ellipsoid. The reflective surfaces share a common focus O within an area of the lens. The LEDs are respectively located at other two focuses M1, M2 of the reflective surfaces. Light rays generated by the at least two LEDs are directed to the reflective surfaces, then reflected towards the lens of the base, and finally reach an outside of the LED lamp through the lens.

### BACKGROUND

1. Field of the Invention

The present invention relates to a light emitting diode (LED) lamp, and more particularly to an LED lamp having good heat dissipation.

2. Description of Related Art

As an energy-efficient light, an LED lamp has a trend of substituting for the fluorescent lamp for a lighting purpose. In order to increase the overall lighting brightness, a plurality of LEDs are often incorporated into a lamp and arranged in a large density. It is well known that the LEDs in a large density generate a lot of heat when emitting light. If the heat cannot be quickly removed, the LED lamp may be overheated, thereby significantly reducing work efficiency and service life of the LED lamp. Therefore, how to efficiently dissipate the heat of the LEDs becomes a challenge for the LED lamp.

What is needed, therefore, is an LED lamp which can efficiently prevent the LEDs from being overheated by the heat generated by the LEDs.

### SUMMARY

An LED lamp according to an exemplary embodiment includes a cover having two concave reflective surfaces, a base disposing over the cover, a lens locating in a middle of the base, and two LEDs mounted on a bottom surface of the base. The lens and the LEDs face the reflective surfaces of the cover. The reflective surfaces each are a part of an ellipsoid. The reflective surfaces share a common focus within an area of the lens. The LEDs are respectively located at other two focuses of the reflective surfaces. Light rays generated by the two LEDs are directed to the reflective surfaces, then reflected towards the lens over the base, and finally reach an outside of the LED lamp through the lens.

Other advantages and novel features of the present invention will become more apparent from the following detailed description when taken in conjunction with the accompanying drawings.

### BRIEF DESCRIPTION OF THE DRAWINGS

Many aspects of the present apparatus can be better understood with reference to the following drawings. The components in the drawings are not necessarily drawn to scale, the emphasis instead being placed upon clearly illustrating the principles of the present apparatus. Moreover, in the drawings, like reference numerals designate corresponding parts throughout the several views.

FIG. 1 is an isometric view of a cover for use with an LED lamp in accordance with a first embodiment of the present invention.

FIG. 2 is an assembled, isometric view of the LED lamp incorporating the cover shown in FIG. 1.

FIG. 3 is an enlarged, isometric view of a circled portion III of FIG. 2.

FIG. 4 is a cross-sectional view of the LED lamp shown in FIG. 2, along a line IV-IV.

FIG. 5 is an isometric view of a cover and four LEDs in accordance with a second embodiment of the present invention.

### DETAILED DESCRIPTION

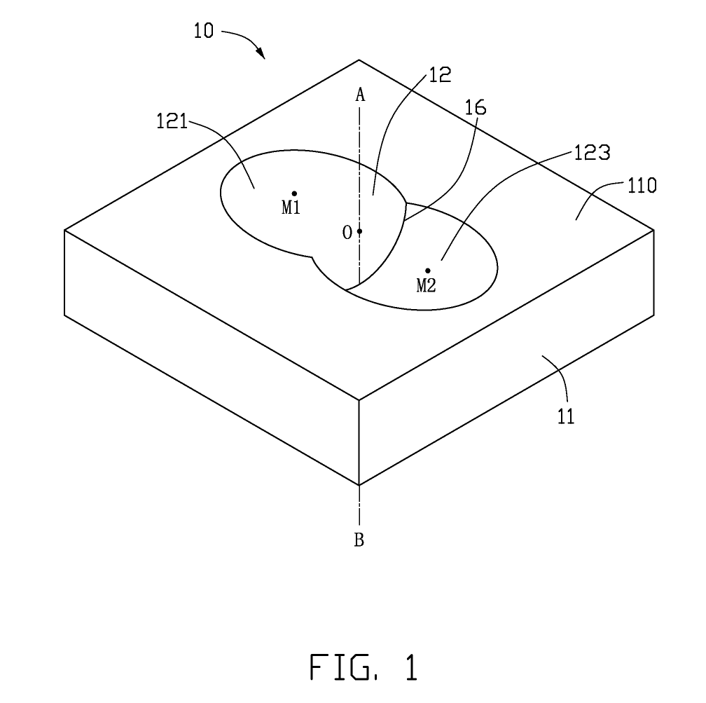

Referring to FIG. 1, a cover 10 for use with an LED lamp in accordance with a first embodiment of the present invention is shown. The cover 10 includes a rectangular main body 11. The main body 11 is made of an opaque material. The main body 11 has a top surface 110. Two concave grooves 12 are defined in a middle part of the top surface 110. The two concave grooves 12 are closely disposed to and communicate with each other. Two reflective surfaces 121, 123 each having a contour of a part of an ellipsoid are defined at a bottom of the grooves 12, respectively. The reflective surfaces 121, 123 intersect with each other at a curve 16 and are symmetrically located at two sides of the curve 16, respectively. A straight line AB is used to indicate a light axis of the LED lamp which extends through a center the curve 16 and is perpendicular to the top surface 110 of the main body 11. Each reflective surface 121 (123) has two focuses M1 and O (M2 and O), wherein the focuses O are coincident with each other. The coincidental focuses O are termed as common focus O throughout the specification.

The reflective surfaces 121, 123 are made to have a high reflectivity or be spread with a high reflective material so as to reflect light rays incident thereon. The reflective surfaces 121, 123 share the common focus O therebetween. The common focus O is located in the line AB. The reflective surface 121 has another focus M1 spaced apart from the common focus O. The reflective surface 123 has another focus M2 spaced apart from the common focus O. The focuses M1, M2 are symmetrically located at two sides of the common focus O, respectively. The focuses O, M, N are located at a same surface as the top surface 110.

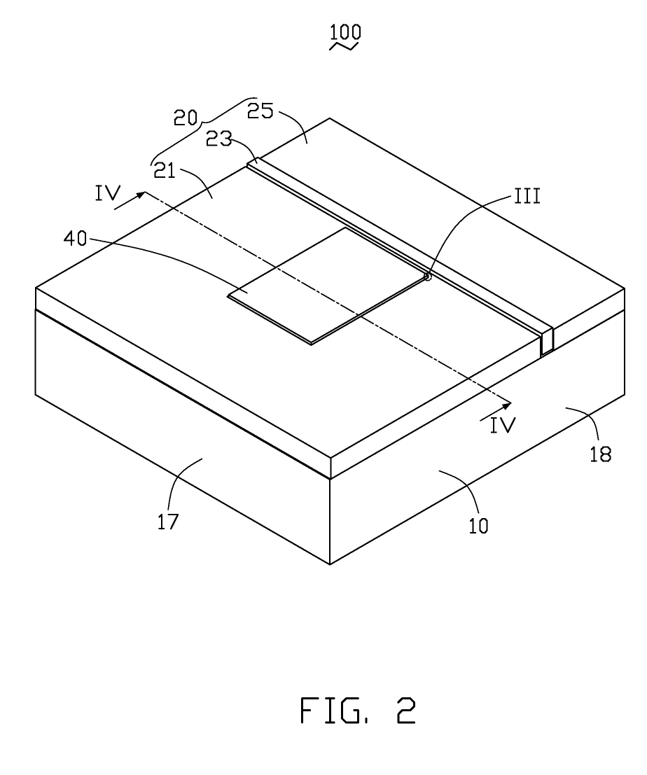

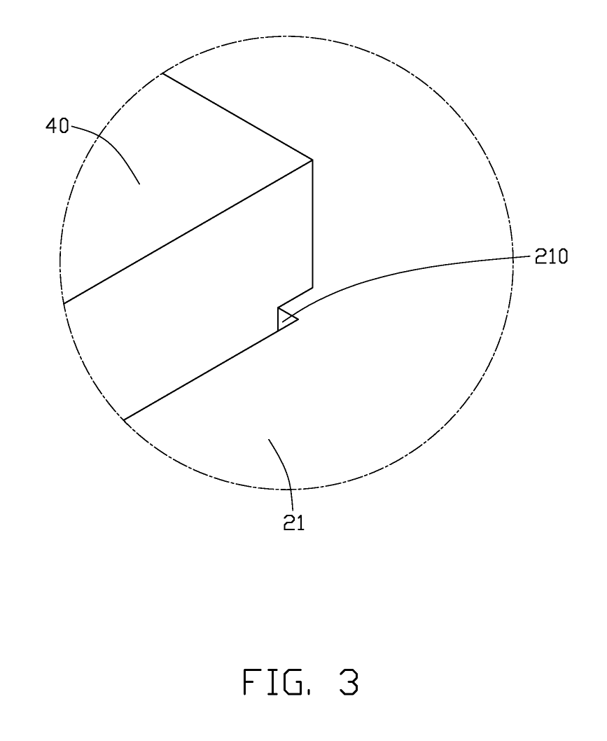

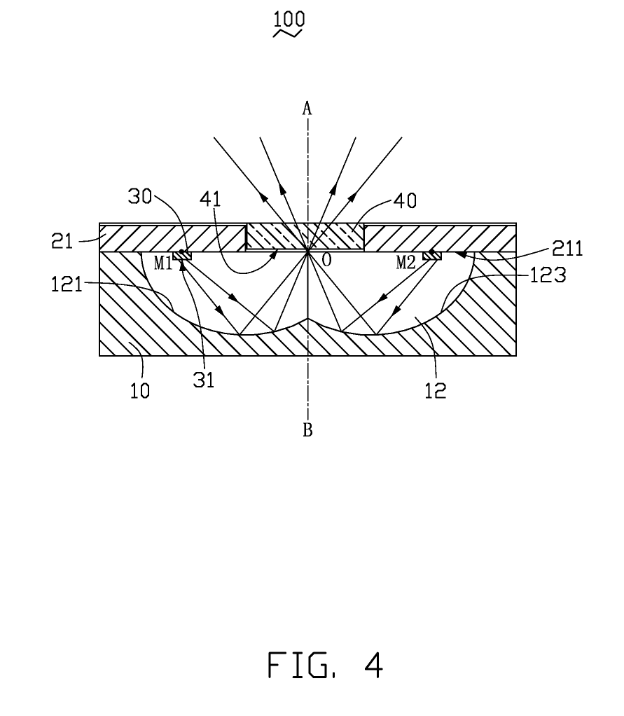

Referring to FIGS. 2 to 4, an LED lamp 100 in accordance with a first embodiment of the present invention is shown. The LED lamp 100 incorporates the cover 10 shown in FIG. 1. The LED lamp 100 further includes a base 20, two LEDs 30 and a lens 40. The base 20 and the lens 40 are disposed on the top surface 110 of the cover 10 for covering the grooves 12.

The base 20 includes a large base portion 21, an insulator 23 and a small base portion 25. The large base portion 21, the insulator 23 and the small base portion 25 each are rectangular and have a same length as that of a side 17 of the cover 10. The large base portion 21, the insulator 23 and the small base portion 25 have ends aligned with each other at another side 18 of the cover 10 and are attached to the top surface 110 of the cover 10. The insulator 23 is located between the large base portion 21 and the small base portion 25.

The large and small base portions 21, 25 each are made of a metallic material having good heat conduction, such as aluminum. The large and small base portions 21, 25 are electrically connected to two electrodes (positive and negative electrodes) of a power, respectively. The insulator 23 is used to electrically insulate the large base portion 21 from the small base portion 25.

The large base portion 21 has a larger area than the small base portion 25 and is disposed over the grooves 12 of the cover 10. The large base portion 21 has a bottom surface 211 facing the grooves 12. The large base portion 21 defines a rectangular hole 210 at a position corresponding to the common focus O of the cover 10. The hole 210 is located equidistantly between the two focuses M1, M2 of the reflective surfaces 121, 123.

The lens 40 has a rectangular shape similar to the hole 210 of the large base portion 21. The lens 40 is depressed into the hole 210 of the large base portion 21 so as to seal the cover 10. The lens 40 has a bottom surface 41 facing the reflective surfaces 121, 123. The common focus O of the reflective surfaces 121, 123 aligns with a center of the lens 40. The line AB is perpendicular to the bottom surface 41 of the lens 40.

The LEDs 30 are respectively received in the grooves 12 and attached to the bottom surface 211 of the large base portion 21. The LEDs 30 each have a light emitting surface 31 facing the corresponding reflective surface 121 or 123 of the cover 10. The LEDs 30 are located at positions corresponding to the focuses M1, M2 of the reflective surfaces 121, 123, respectively. One of the LEDs 30 is disposed at the focus M1 of the reflective surface 121, while the other one of the LEDs 30 is disposed at the focus M2 of the reflective surface 123. Fluorescent powder can be used in the LEDs 30 or the lens 40.

In operation, light rays emitted by the light emitting surface 31 of the LEDs 30 are directed to the reflective surfaces 121, 123. Because the LEDs 30 are located at the focuses M1, M2 of the reflective surfaces 121, 123, respectively, and the common focus O of the reflective surfaces 121, 123 is located within an area of the lens 40, all of the light rays incident on the reflective surfaces 121, 123 are reflected by the reflective surfaces 121, 123 to the lens 40 at the common focus O, and then pass through the lens 40 to reach ambient air over the LED lamp 100.

In the LED lamp 100, the LEDs 30 respectively located at the focuses M1, M2 are spaced from each other a distance between the two focuses M1, M2, so that heat generated by the LEDs 30 can be widely dispersed into the large base portion 21. Therefore, the LED lamp 100 is prevented from becoming overheated and has a high work efficiency and a long service life. Furthermore, the light rays of the LEDs 30 can be converged together so as to provide a strong light source.

In alternative embodiments, the cover 10 and the lens 40 are not limited to rectangular shape and may have circular or other shapes.

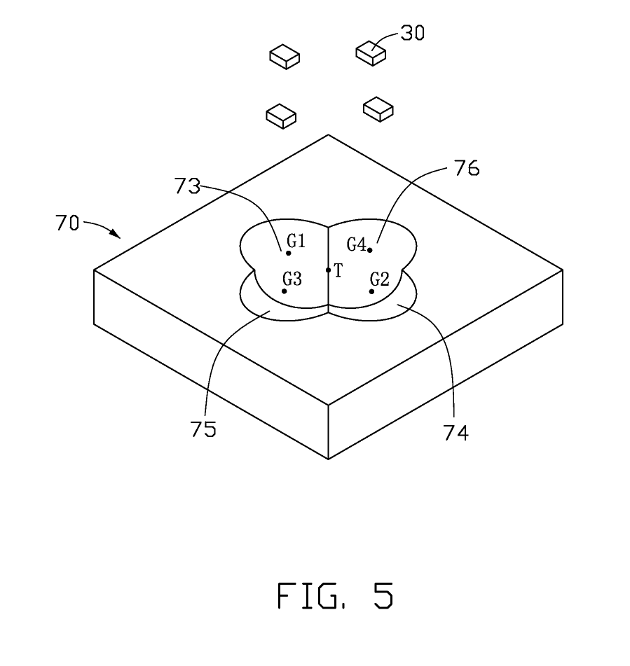

In alternative embodiments, the number of the reflective surfaces can be more than two according to actual need, as long as the reflective surfaces each has a focus coincidental with each other. In other words, the reflective surfaces share a common focus. Referring to FIG. 5, a cover 70 and four LEDs 30 for use with an LED lamp in accordance with a second embodiment of the present invention are shown. The cover 70 has a configuration similar to the cover 10, only differing from the cover 10 in the number of the reflective surfaces. The cover 70 defines four concave reflective surfaces 73, 74, 75 and 76 each having a contour of a part of an ellipsoid. The four reflective surfaces 73, 74, 75, 76 share a common focus T in a middle thereof. The four reflective surfaces 73, 74, 75, 76 each have another focus, as indicated by G1, G2, G3, G4, respectively. Two opposite reflective surfaces 73, 74 or 75, 76 are symmetrically configured in respect to the common focus T. The reflective surfaces 73, 74, 75, 76 are made to have a high reflectivity or be spread with a high reflective material. In assembly, the four LEDs 30 are respectively located at positions corresponding to the four focuses G1, G2, G3, G4 of the reflective surfaces 73, 74, 75, 76, respectively.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An LED lamp comprising:
a base having a light penetrable part thereof; and
at least two LEDs mounted on the base,
a cover having at least two concave reflective surfaces, wherein
the base is disposed over the cover with the light penetrable part and the at least two LEDs facing the at least two concave reflective surfaces of the cover, the at least two concave reflective surfaces each are a part of an ellipsoid, the at least two concave reflective surfaces share a common focus within an area of the light penetrable part of the base, the at least two LEDs are respectively located at other at least two focuses of the at least two concave reflective surfaces other than the common focus, light rays generated by the at least two LEDs are directed to the at least two concave reflective surfaces, then reflected towards the light penetrable part of the base, and finally reach an outside of the LED lamp.

2. The LED lamp as claimed in claim 1, wherein the at least two concave reflective surfaces intersect with each other at a curve.

3. The LED lamp as claimed in claim 2, wherein the at least two concave reflective surfaces are symmetrically located in respect to the curve.

4. The LED lamp as claimed in claim 1, wherein the number of the at least two concave reflective surfaces is four, the number of the at least two LEDs is four, the four reflective surfaces share a common focus, and the four LEDs are located at positions corresponding to four other focuses of the four reflective surfaces, respectively.

5. The LED lamp as claimed in claim 1, wherein the cover includes a rectangular main body, and the at least two concave reflective surfaces are defined in a top surface of the main body.

6. The LED lamp as claimed in claim 5, wherein the main body is made of an opaque material.

7. The LED lamp as claimed in claim 1, wherein a hole is defined in the base at a position corresponding to the at least two concave reflective surfaces, and a lens is depressed into the hole of the base so as to form the light penetrable part of the base.

8. The LED lamp as claimed in claim 7, wherein the base includes a first base portion, an insulator and a second base portion, the first base portion is bigger than the second base portion, the insulator is located between the first base portion and the second base portion to electrically insulate the first base portion from the second base portion, and the hole is defined in the first base portion.

9. The LED lamp as claimed in claim 7, wherein the lens is located between the at least two LEDs, and the common focus of the at least two concave reflective surfaces of the cover aligns with a center of the lens.

10. A cover for use with an LED lamp, comprising:
at least two concave reflective surfaces defined at a side thereof, the at least two concave reflective surfaces each being a part of an ellipsoid and the at least two concave reflective surfaces sharing a common focus, each of the at least two concave reflective surfaces having another focus adapted for mounting an LED thereat.

11. The cover as claimed in claim 10, wherein the at least two concave reflective surfaces are symmetrically located in respect to the common focus.

12. The cover as claimed in claim 10, wherein the at least two concave reflective surfaces intersect with each other at a curve.

13. The cover as claimed in claim 12, wherein the at least two concave reflective surfaces are symmetrically located in respect to the curve.
